(19) United States
(12) Patent Application Publication
(10) Pub. No.: US 2010/0052275 A1
(43) Pub. Date: Mar. 4, 2010

(54) FOLDABLE GOLF BAG CART

(75) Inventors: Eric W. Reimers, Missoula, MT (US); Dale Truett, Missoula, MT (US); Mark Robirds, Florence, MT (US)

Correspondence Address: IPLO-Intellectual Property Law Offices, 95 SOUTH MARKET STREET SUITE 570, San Jose, CA, 95113, US

(73) Assignee: Sun Mountain Sports, Inc., Missoula, MT (US)

(21) Appl. No.: 12/544,083

(22) Filed: Aug. 19, 2009

Related U.S. Application Data
(60) Provisional application No. 61/092,891, filed on Aug. 29, 2008.

(51) Int. Cl. B62B 1/00; B62B 3/00

(52) U.S. Cl. 280/47.26; 280/651

(57) ABSTRACT

A golf bag cart (10) for a golf bag (12) is provided for transporting the bag (12). The golf bag cart (10) includes a four wheeled carriage (18), a bag support frame (20) and a handle (22). The bag support frame (22) includes a base frame (36) and a pivotally attached torso frame (64), with a slider block (62) on said base frame (36) providing a mechanism for collapsing and expanding said golf bag cart (10) between a use mode (14) and a storage mode (16) in conjunction with the pivoting of the torso frame (64). The handle (22) is pivotally securable at multiple pivot angles.

This is a non-provisional application. It is based, in part, and claims priority from two U.S. Design Patent applications of the same inventors, these being U.S. Ser. No. 29/323,238, filed 22 Aug. 2008 and U.S. Ser. No. 29/323,422 filed 26 Aug. 2008 and from the provisional application No. 61/092,891, filed 29 Aug. 2008, all on behalf of the same inventors.

### TECHNICAL FIELD

The present invention relates generally to accessories for golfers and particularly to methods for transporting golf bags used by golfers.

### BACKGROUND ART

Although the purists in the golf community insist that the only way to properly play golf is to carry the golf bag, either personally or through the use of a caddy, many golfers prefer to use carts to transport the golf bags and associated equipment. While riding carts are required by many courses, a great number of players desire to gain the exercise benefits of walking during the round, without carrying the bag and equipment. For this reason walking carts are popular.

For many years pull carts, usually two-wheeled, were the norm. However, with the introduction in 2000 of the SPEED CART® three-wheeled push cart (U.S. Pat. Nos. 6,698,789 and 7,128,333) from Sun Mountain Sports, Inc. the landscape changed. Push carts, particularly collapsible push carts, have become the most popular versions.

Nonetheless, demand continues for more compact, more stable, more convenient and lighter golf bag carts.

### DISCLOSURE OF INVENTION

Accordingly, it is an object of the present invention to provide an improved collapsible golf bag cart for transporting a golf bag in a highly stable manner.

Another object of the invention is to provide a bag cart system which transitions by expansion and collapsing between a folded (storage) state and an expanded (operational) state with great ease and rapidity.

A further object of the present invention is to provide a bag cart system which is very lightweight in comparison to prior art carts with similar features.

Yet another object of the invention is to provide a cart which expands and collapses with a minimal number of operational steps.

Another object of the invention is to provide a multi-position handle arrangement for the convenience of the golfer.

Briefly, one preferred embodiment of the present invention is a golf bag push cart having a bag support frame, a four-wheeled carriage, and a handle. The cart is pivotally assembled in such a manner that it easily collapses into a compact storage mode and conversely unfolds into an expanded mode suitable for loading a golf bag for transport. The cooperation of a slider block on the bag support frame and a pair of parallelogram structures in the carriage facilitates the transitions.

An advantage of the present invention is that it provides great stability with all four wheels touching the ground in both expanded and collapsed modes.

Another advantage of the invention is that it has a wheelbase which is greatly expanded on two axes when expanded, thus provided excellent stability when loaded with a golf bag.

An additional advantage of the invention is that parallel alignment of the wheels is maintained in all orientations, including transitional.

Yet another advantage of the present invention is that the tubular construction and lightweight materials result in a strong but lightweight cart which is easily lifted and handled by most golfers.

Still another advantage of the present invention is that it expands and collapses is an essentially seamless transition with a minimum of operator-assisted steps.

A still further advantage of the present collapsible golf bag cart invention is that it grasps and retains a golf bag without cumbersome fastener elements which can dangle or interfere with collapsing or storage.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 is a perspective view of the expanded mode of the present invention, shown with a typical golf bag carried thereon;

FIG. 2. is a bottom plan view of the golf bag cart of the present invention, shown in the folded mode;

FIG. 3. is a front view of the invention in the expanded mode of the invention;

FIG. 4. is a left side view of the expanded mode;

FIG. 5. is a rear plan of the expanded mode of the invention;

FIGS. 6A through 6D are dynamic schematic views of the invention showing the transition between the folded mode and the expanded mode; and

FIG. 7 is a cross sectional view of a spring latch member.

### BEST MODE FOR CARRYING OUT THE INVENTION

The present invention is collapsible golf bag cart used to transport golf bags loaded with golf clubs and accessories. The collapsible cart is referred to by the general reference character 10 in the drawings and description. The collapsible cart 10 may be used with various golf bags and may exist in multiple embodiments.

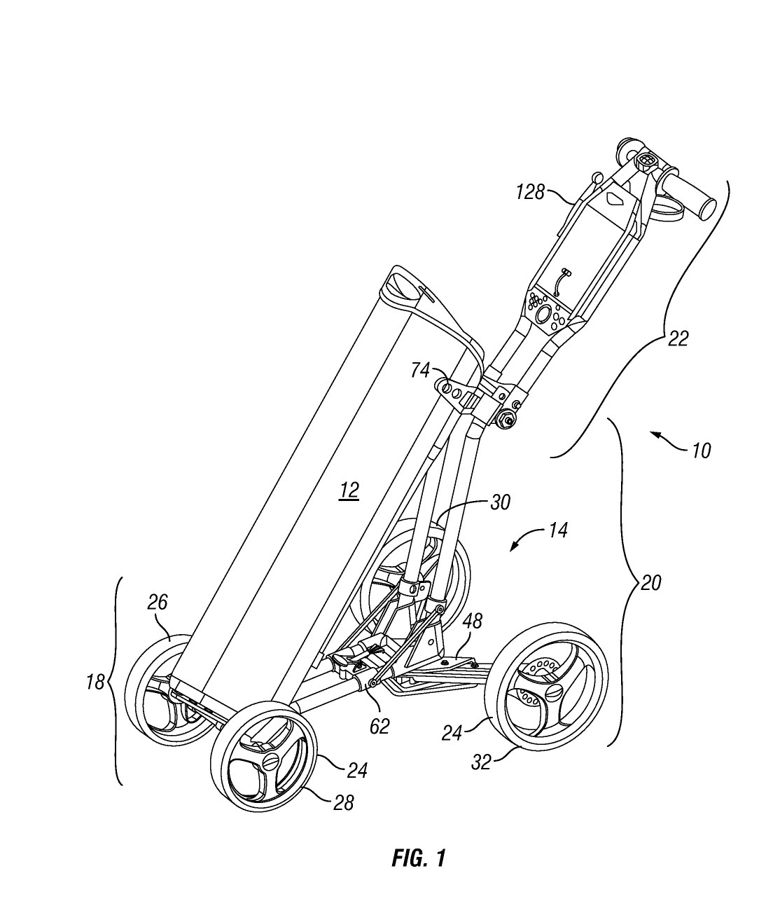

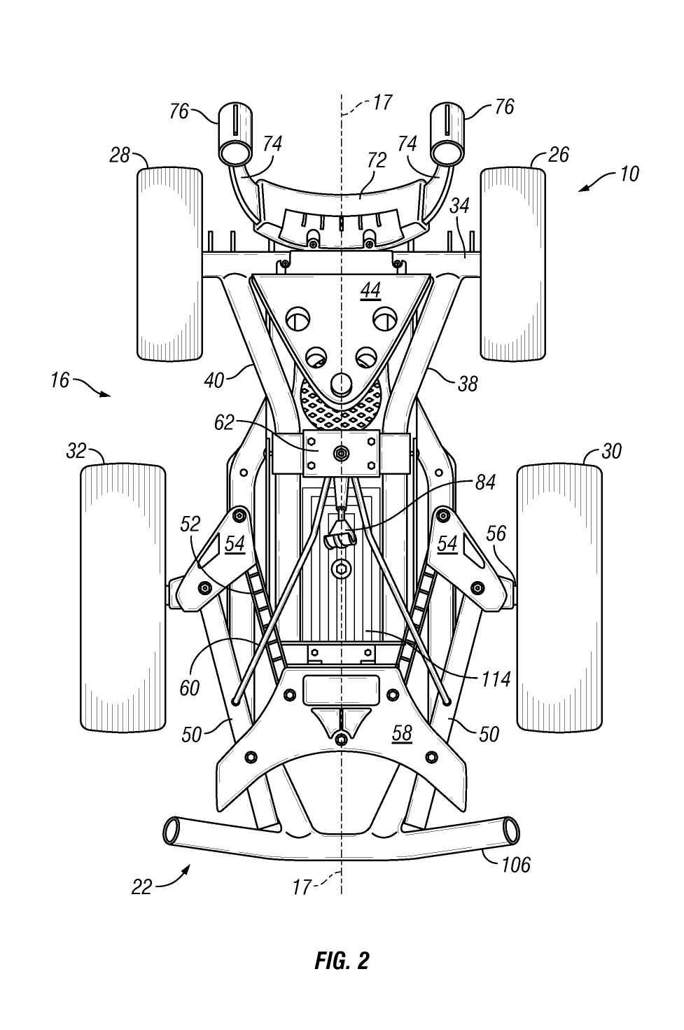

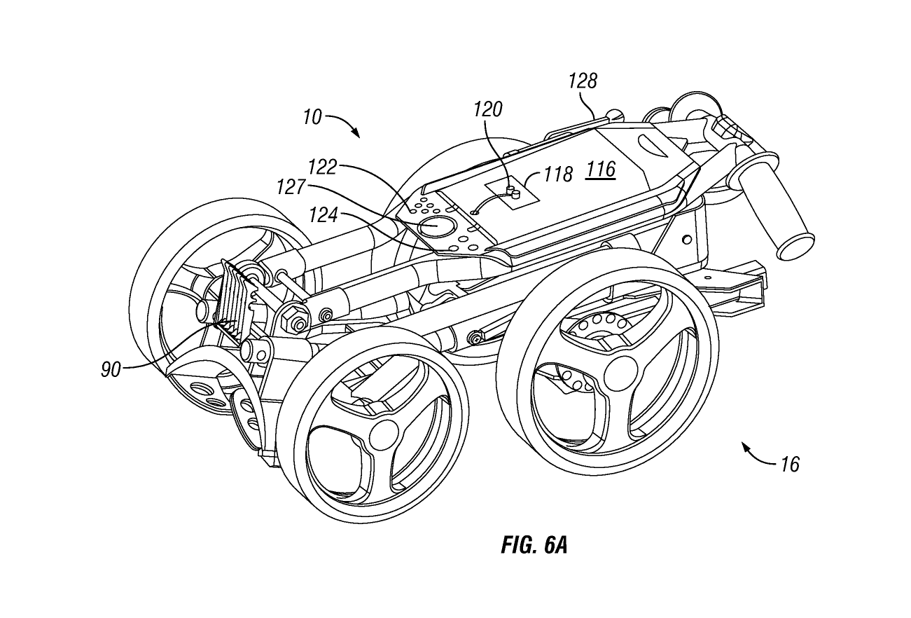

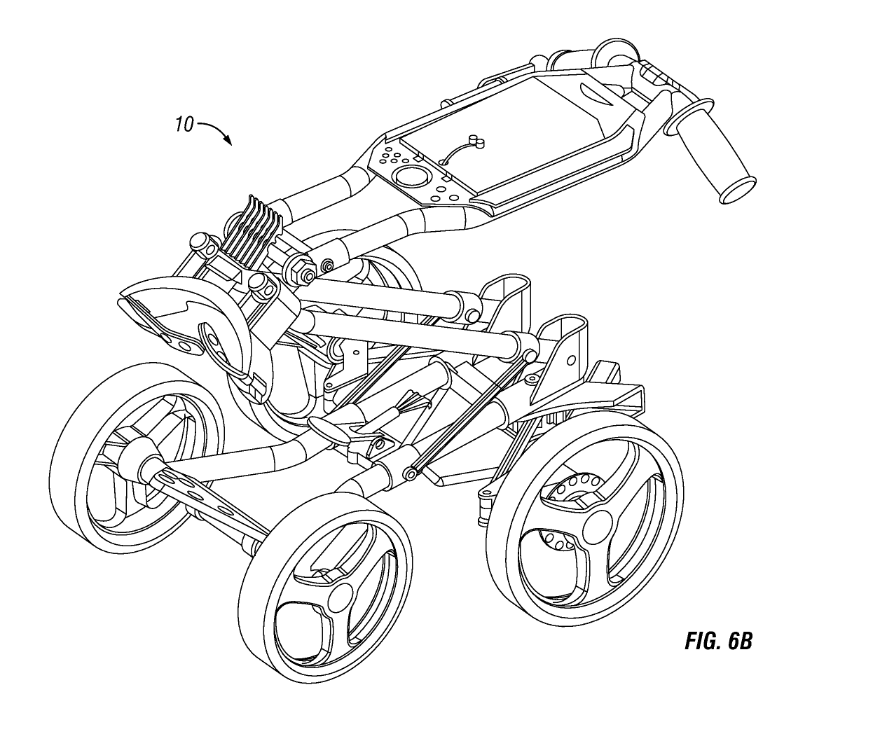

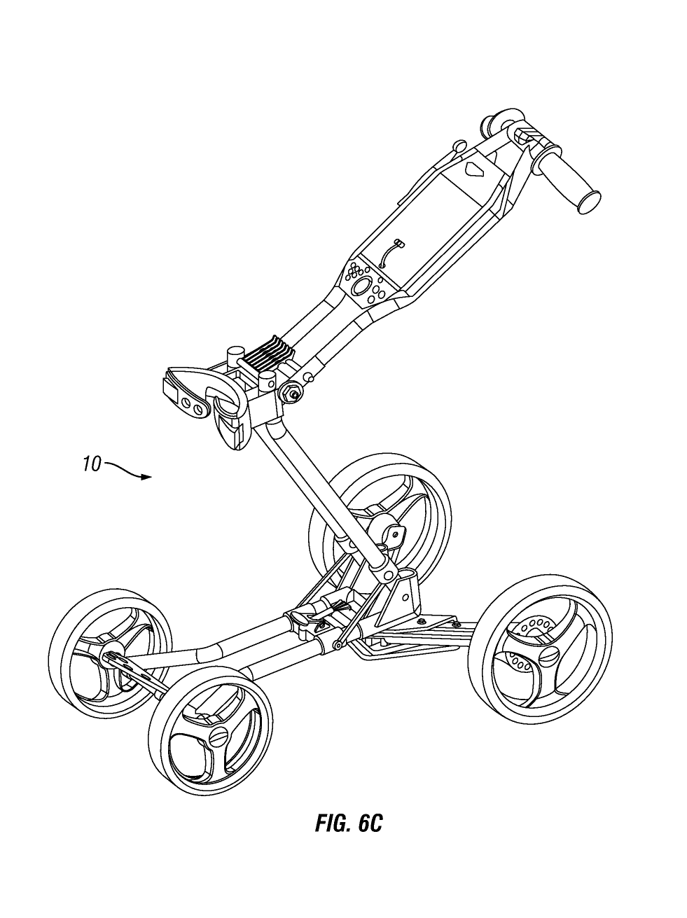

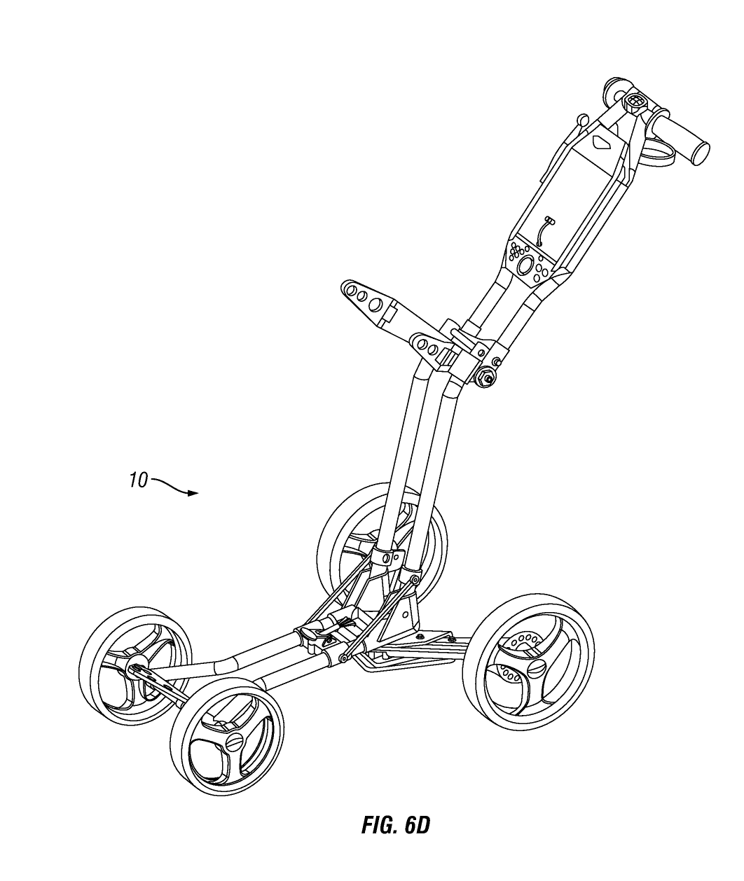

In one preferred embodiment of the invention illustrated in FIG. 1, the collapsible cart 10 is shown in a perspective view as transporting a typical golf bag 12, in this case, a golf bag from Sun Mountain Sports, Inc. of Missoula, Mont. The golf bag 12 is not a part of the invention, but is shown to illustrate how the invention is typically used. The cart 10 is illustrated in FIG. 1 in an expanded mode 14, also known as the “use” mode, where it is capable of carrying and transporting the golf bag 12. The invention is illustrated in FIG. 2 in a folded mode 16 or “storage” mode where it is collapsed into a minimal volume configuration for compact storage in an auto trunk compartment or garage, for example. The transition between the folded mode 16 and the expanded mode 14 (and back) is illustrated in FIG. 6 and discussed later herein.

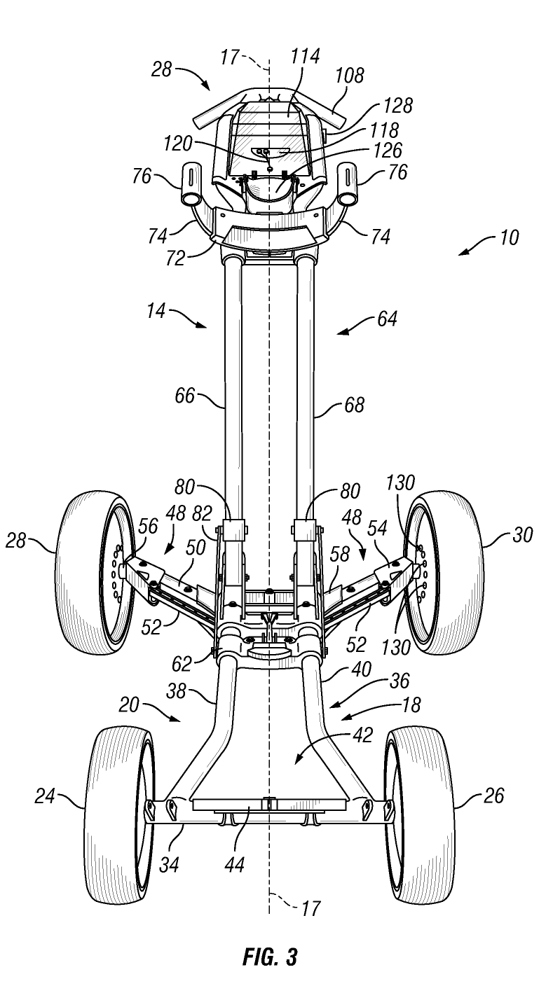

One more recently preferred embodiment of the invention is illustrated in FIGS. 1 and 4 through 7, while a previously preferred embodiment is shown in FIGS. 2 and 3. The embodiments are generally functionally identical and both are referred to as the golf bag cart 10.

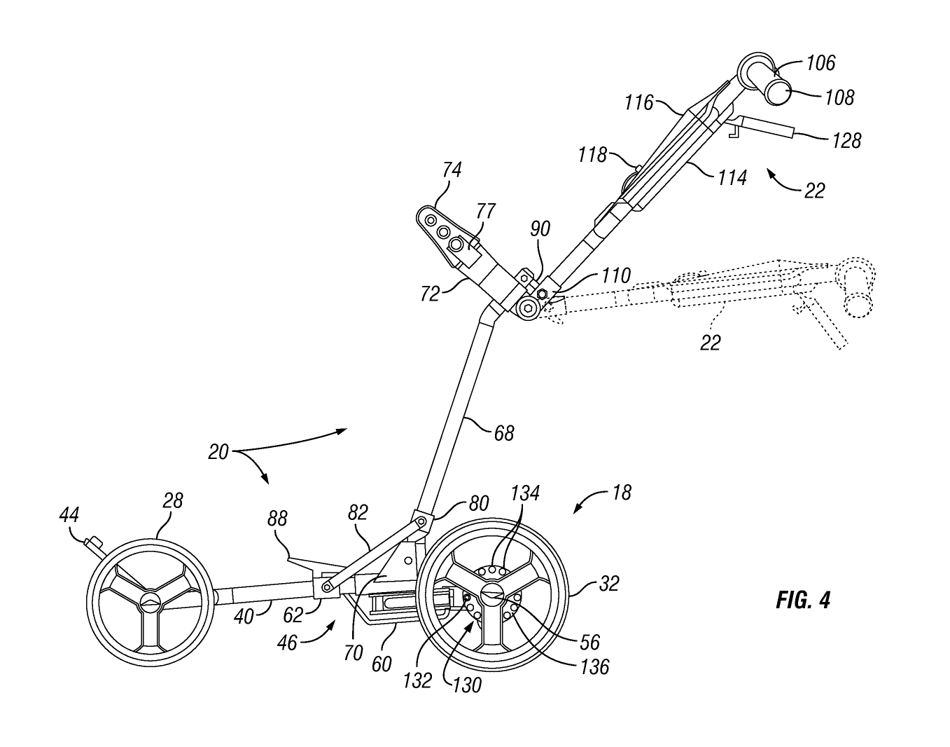

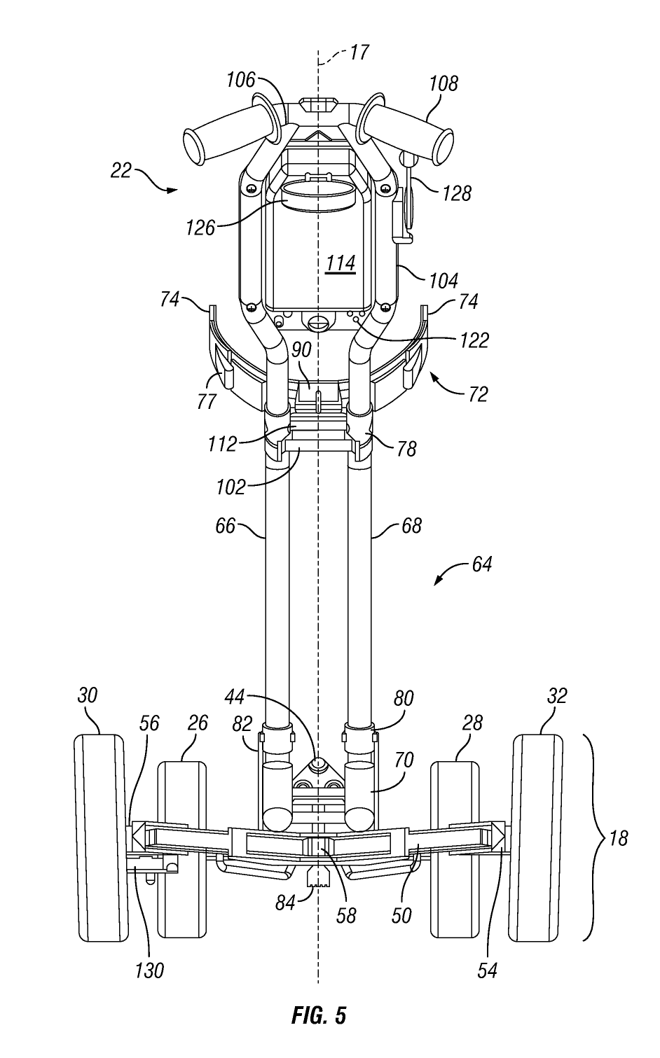

Although the perspective view of FIG. 1 and the other views illustrated in the drawings show various components of the collapsible golf bag cart invention 10, the discussion will focus primarily on the top front view of FIG. 3 and the side and rear view of FIGS. 4 and 5. The preferred embodiments 10 are generally laterally symmetrical about a vertical plane 17 with corresponding left and right components (or components which are bisected by the plane 17). The cart 10 may be thought of as having various principal assembles or subsystems which operate together in order to function as a compact, lightweight and extremely easy to use method of transporting a golf bag on the rolling surfaces of a golf course and in other locations such as parking lots and storage facilities. The primary subassemblies include a carriage 18, a bag support frame 20 and a handle 22. It is understood that some components of the invention are a part of more than one of the subassemblies.

The most obvious components of the carriage 18 are four wheels 24, including a front left wheel 26, a front right wheel 28, a left rear wheel 30 and a right rear wheel 32. The four wheels 24 provide stable rolling support for the cart 10 both in the expanded mode 14 and the folded mode 16. In the expanded mode 14 (FIGS. 1, 3, 4, 5 and 6D) the rear wheels 30 and 32 are farther apart and rearward of the support frame 20 while in the folded mode 16 (FIGS. 2 and 6A), the rear wheels 30 and 32 are closer together and overlap the support frame 20. The progression of the rear wheels 30 and 32 is illustrated in the several sub-figures of FIG. 6. The front wheels 26 and 28 are fixed in position on a front axle tube 34. The rear wheels 30 and 32 have a greater diameter than the front wheels 26 and 28 in the preferred embodiment and the front wheels 26 and 28 are maintained in a fixed separation throughout (narrower than the separation of the rear wheels 30 and 32 in the expanded mode 14).

The carriage 18 overlaps with the support frame 20, and the lower portion of the frame 20 also forms a portion of the carriage 18. A base frame structure 36 is formed (integrally in the preferred embodiment 10) of the front axle tube 34, a left base tube 38 and a right base tube 40. The base tubes 38 and 40 are spaced apart and parallel at the portions removed from the front axle 34 but are bent outward nearer the front axle to form therewith a bag cradle 42. As may be seen and surmised from FIG. 1, the bag cradle 42 receives and supports the bottom of the golf bag 12, with the front axle 34 preventing downward sliding of the bag 12 and the base tubes 38 and 40 restricting lateral sliding and twisting. A bag bottom flap 44 (shown extended in FIGS. 3 and 5 and rotated inward in FIG. 2) provides additional support to the bottom surface of the golf bag 12. The bag bottom flap 44 pivots about the front axle tube and is restricted to rotational extremes as shown in FIGS. 2 and 3.

A rear suspension assembly 46 connects the rear wheels 30 and 32 to the frame 20, as best seen in FIGS. 2 and 3. The rear suspension 46 includes a pair (one on each side) of parallelogram structures 48, each including a heavy gauge load bearing arm 50 and a lighter positioning arm 52. The arms 50 and 52 connect at their distal ends to axle pivot brackets 54. Each axle pivot bracket 54 includes an axle pin 56 upon which the associated rear wheel (30 or 32) is rotatably mounted. The other ends of the arms 50 and 52 are pivotally connected to a central V bracket 58 (see FIG. 2). The V bracket 58 is mounted to and below the rear ends of the base tubes 38 and 40. The parallelogram structures 48 maintain the rear wheels in parallel relationship to one another (including to the front wheels) at all points of expansion or contraction (See FIG. 6).

As seen in FIG. 2, particularly, a pair of connector rods 60 extend from the load bearing arms 50 to a slider block 62 which is slidably mounted on the base frame 36. The slider block 62 (also shown in FIG. 3) slides upon the straight parallel portions of the base tubes 38 and 40.

The portion of the bag support frame 20 which is upright in the expanded mode 14 is referred to herein as the torso frame 64. The torso frame 64 includes a left torso tube 66 and a right torso tube 68 which are arrayed in parallel. Each torso tube 66 and 68 of the torso frame 64 pivotally connects to the base frame 36 at a frame pivot bracket 70 (see, esp.

FIGS. 4 and 5). The frame pivot bracket 70 has a raised rear edge which prevents the torso frame 64 from pivoting to a position farther than that desired to achieve the angle shown in the expanded mode 14.

The upper end of the torso frame 64 supports a bag top receiver 72. The bag top receiver includes a pair of flexible mandibles 74 extending forward therefrom. In some embodiments (see FIG. 3) the mandibles 74 include terminal grip ends 76. The upper portion of the golf bag 12 is forced between the mandibles 74 until the grip ends 76 (or the ends of the curved mandibles 74 themselves) hold the bag relatively firmly (if elastically) in position, with the bag bottom being already seated in the bag cradle 42 (see FIG. 1). In a deluxe embodiment (see, especially, FIGS. 4 and 5), no grip ends 76 are required and the mandibles 74 are hingedly attached with the tension on the mandibles 74 being adjustably controlled by tension screws 77. The tension screws 77 (one per mandible 74) adjust the gripping tension of the mandibles 74 about the golf bag 12 to a desired level in order to firmly elastically grasp the particular golf bag 12 of the user, in a manner described and claimed in U.S. Pat. No. 7,581,748 to inventor Reimers.

A handle pivot 78 is also attached to the upper end of the torso frame 64 to provide a pivotal attachment for the handle assembly 22. The handle pivot 78 extends across between the upper ends of torso tubes 66 and 68.

Near the lower end of the torso frame 64 an attachment collar 80 is secured to each of the left torso tube 66 and the right torso tube 68. Each attachment collar 64 is pivotally connected to one end of a force extension 82 (see FIGS. 3 and 4). Each force extension 80 is a rigid metal extension; an elongated flat plate in the preferred embodiment 10. The other end of each force extension is pivotally secured to the slider block 62 on the base frame 36. Pivotal rotation of the torso frame 64 on the frame pivot bracket 70 causes the force extensions 82 to slide the slider block 62 either forward or rearward along the base frame 36, depending on the direction of the pivot. This correspondingly causes the connector rods 60 to push or pull on the parallelogram structures 48 which causes the rear wheels 30 and 32 to move forward and inward or rearward and outward depending on the direction of pivot of the torso frame 64 (see FIG. 6). Thus pulling upward on the handle 22, and consequently the torso frame 64, from the folded mode 16 causes the cart 10 to smoothly transition to the expanded mode 14. Conversely pushing forward and downward on the handle 22, and consequently the torso frame 64, results in the reverse transition, all without the necessity of touching any other part of the cart 10. The terminal and selected intermediate steps of the reversible transition are illustrated in the various subfigures of FIG. 6.

Gravity and minor friction act to retain the cart 10 in the folded mode 16 and minor friction and the insertion of a golf bag 12 hold the cart in the expanded mode 14. However, it is desirable in some circumstances to provide physical locks to improve stability.

For maintenance of the fully extended rear suspension 46 desired for the expanded model 14, a cam buckle 84 is provided on the upper surface of the slider block 62. The cam buckle 84, which is adjustable in length (preferably via a rotational mount and a screw extender), is adapted to engage a cam catch ledge 86 on the upper surface of the V bracket 58. When the slider block 62 is nearly adjacent to the V-block 58 in the expanded mode 14, the cam buckle 82 is engaged with the cam catch ledge 86 and a cam lock paddle 88 (see FIG. 5) is flipped forward to lock the engagement. This prevents the slider block 62 from moving and both maintains the rear suspension 46 in full extension and prevents the torso frame 64 from pivoting forward. The cam lock paddle 88 is flipped backward to release the cam lock buckle 84 when it is desired to collapse the cart 10. It is noted that locking the cam buckle 84 also forces the torso frame 64 to remain in the expanded mode position, since the slider block 62 is immobilized and the force extensions 82 consequently hold the torso frame 64 upright.

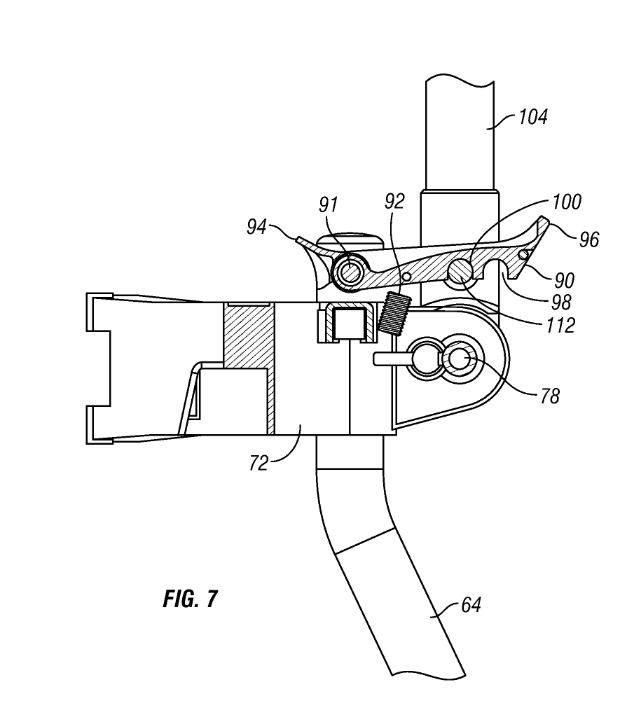

A spring latch 90, shown in detail in FIG. 7 and visible in FIGS. 4 and 5, acts to maintain the cart 10 in the folded mode 16 and also to hold the handle 22 in the proper rotational position for the user. The spring latch member 90 includes: a pivot pin 91, extending between the torso tubes 66 and 68, about which the latch 90 pivots; a spring 92 connecting it to the bag top receiver 72 and providing anti-rotational resilient force; a flip projection 94 facilitating depression of one end to rotate the opposing end; a high friction surface 96 opposite the spring 92; a first grasping notch 98; and a second grasping notch 100.

The handle pivot 78 includes a cross tube 102 (FIG. 5) which extends across between the torso tubes 66 and 68. When the handle 22 is fully folded and the cart 10 is in the folded mode 16, the latch 90 has the high friction surface 96 engaging the cross tube 102 in such a manner that movement is restricted and a touch on the flip projection 94 is helpful to release the components for expansion.

The spring latch 90 also serves the purpose of holding the handle 22 in position in the expanded mode 14. The handle 22 includes a pair of shaped handle tubes 104 which extend from the handle pivot 78 to a handlebar 106, having optional grips 108. A pair of rod collars 110 are affixed to the handle tubes 104 at a position slightly removed from the cross tube 102. A latch rod 112 extends across between the rod collars 110. The latch rod 112 is adapted to fit into and mate with the grasping notches 98 and 100 of the spring latch 90. When the handle 22 is rotated to the extent that the latch rod 112 engages the first grasping notch 98, the handle 22 is positioned at an intermediate height for those desiring a lower handle position (shown in phantom in FIG. 4). When the handle 22 is rotated fully so that the latch rod 112 engages the second grasping notch 100, the handle is locked into a higher position as shown in the figures depicting the expanded mode 14.

The handle subassembly 22 of the preferred embodiment 10 also includes a variety of convenience features (see FIG. 6A) for the use of a golfer during a round of golf. One such feature is a storage console 114 with a transparent lid 116 hingedly attached thereto. The storage console 114 provides a compartment where the golfer can place yardage books, golf balls, notes, a slim wallet or other items to which occasional access may be desired during the round. The transparent lid 116 includes a ferromagnetic plate 118 which mates with a pair of small but powerful cord-suspended magnets 120. This magnetic combination is used to secure a scorecard against the surface of the lid 116 for easy access and use. Tee apertures 122 and pencil apertures 124 are formed in the extended frame of the console to receive and store frequently accessed golf tees and pencils during the round. A pivotally mounted drink holder 126 is also mounted between the handle tubes 104 just below the storage console 114 in the embodiment of FIG. 3 and just below the handlebars 108 in FIGS. 1, 5 and 6, for the golfer to place a cup, can or bottle during the round. The drink holder 126 is pivotally mounted so that gravity maintains it in a nearly vertical poison to avoid spillage, regardless of the vertical angle of the handle 22. A ball marker depression 127 is also provided to receive a golf ball, either for temporary storage of to hold it in position for marking the ball with a permanent marker for easy identification as the player's own ball.

A hand brake 128 (see FIGS. 1, 4 and 5 especially) is also provided on the handle 22 to allow the golfer to provide extra security when using the cart 10 on a sloping area. Manipulation of the hand brake 128 causes a brake engagement structure 130 associated with one of the rear wheels (the right rear wheel 32 as shown in the drawings) where a brake pin 132 will engage with one of a circumferentially arrayed series of engagement depressions or pin receiving holes 134 either on the interior of the a solidly constructed wheel hub (as shown in FIGS. 2 and 3) or on a brake disc 136 in a spoke version of the rear wheel as shown in the remaining figures.

The preferred embodiment is primarily constructed of tubular anodized aluminum for light weight and durability. The wheels 24 are formed of lightweight structural plastic with cushioned traction surfaces and may either be provided with solid hubs or spoke hubs. In some embodiments rubberlike friction surfaces are also provided.

Many modifications to the above embodiment may be made without altering the nature of the invention. The dimensions and shapes of the components and the construction materials may be modified for particular circumstances or types of bags to be carried.

While various embodiments have been described above, it should be understood that they have been presented by way of example only, and not as limitations.

### INDUSTRIAL APPLICABILITY

The collapsible golf bag cart 10 of the present invention is intended for use primarily by golfers who desire maximum convenience and safety while transporting a golf bag on a walking round. The cart 10 is lightweight and is extremely compact to facilitate storage. It expands and folds with an absolute minimum of effort; requiring only two steps in folding and only a single movement step in expanding for many uses. The expanded mode 14 is very stable for rolling and supporting the golf bag 12 during the round. The cart 10 also requires no straps or other fasteners to retain and support the golf bag, thus minimizing the amount of loose or dangling components and reducing effort.

For typical use, the golf bag cart 10 will begin in the folded mode 16, for storage. In this mode it has only the effective height of the rear wheels (30 and 32) and slightly greater lateral extent than the width of the front wheels (26 and 28) so the cart easily fits into an automobile trunk or on a garage shelf. Even in collapsed mode 16, however, the wheels 24 are free and the cart 10 can be rolled to desired locations (providing that the hand brake 128 is not engaged).

When the golfer has moved the folded mode 16 cart to the desired location [easily done since it weighs only a bit more than 5 kilograms (12.5 lbs) unloaded] it is time to expand it and load a golf bag 12. To do this the golfer simply grasps the handlebar 106, tweaks the flip projection 94 (perhaps with a foot) to disengage the spring latch 90, and lifts up on the handle 22. As shown in the transition sequence of FIG. 6 (A-D), the cart 10 unfolds smoothly from the storage mode 16 of FIG. 6A through the intermediate positions of FIGS. 6B and 6C to the fully expanded mode 14 of FIG. 6D. The illustrations of FIG. 6 presume that the first grasping notch 98 is bypassed and the handle 22 is pulled upright all the way to engage the latch rod 112 with the second grasping notch 100. When this engagement occurs, the spring latch 90 holds the handle 22 in position and the expansion is complete. The user may then desire to secure the expansion further by engaging the cam buckle 84 with the cam catch ledge 86 and locking the position by flipping the cam lock paddle 88. The bag bottom flap 44 is flipped from its storage location (FIGS. 2 and 6) to a support position (FIGS. 3 and 5).

The golf bag 12, ordinarily fully loaded with clubs, is then engaged with the cart 10 by placing the bottom of the bag into the bag cradle 42 and gently forcing the upper end of the bag 12 into the bag top receiver 72. The mandibles 74 are elastic enough to easily spread apart to accept the tops of most golf bags and once the softer sides of the golf bag 12 are engaged by the grip ends 76, the resilient force of the mandibles 74 holds the bag 12 firmly, if releasably in position. The user may wish to adjust the force on the mandibles 74 by use of the tension screws 77 to more firmly or loosely grasp a particular golf bag. The golfer is now ready to go out and enjoy the round, quite possibly while enjoying a beverage held in the gravity-centered drink holder 126.

During the round, the golfer may have occasions to prevent the cart 10 form rolling. In such cases the brake engagement structure 130 is engaged by rotating the hand brake lever 128, which will cause the brake pin 132 to enter a depression or receiving hole 134 on the brake disc 136 (slight rotation of the wheel 32 may be necessary in order to line up the brake pin 132 with a receiving hole 134). Rotation of the hand brake lever 128 back to its original position pulls the pin 132 and releases the brake engagement 130.

When the round is over, the golfer simply: removes the bag 12 from the cart 10; flips the bag bottom flap 44 back over into the bag cradle 42; pops the cam lock paddle 88 to release the cam lock buckle 84; depresses the flip projection 94 to release the handle 22; and collapses the cart 10 back to the storage mode 16 by gravity and folding the handle 22 inward and forward.

The extreme convenience, ease of operation, compactness of storage volume and light weight of the inventive cart 10 make it a joy to own and use and a desirable accessory for any golfer who wishes to walk the course without carrying the weight of the bag.

For the above, and other, reasons, it is expected that the collapsible golf bag cart 10 of the present invention will have widespread industrial applicability. Therefore, it is expected that the commercial utility of the present invention will be extensive and long lasting.

What is claimed is:

1. A golf bag cart, comprising:
a golf bag support frame, when expanded into a use mode, for receiving and releasably capturing a golf bag;
a four wheeled carriage supporting said frame, said carriage including a collapsible rear suspension which causes said rear wheels to collapse in parallel fashion forward and inward toward said frame; wherein
said support frame collapses downward into a storage mode, with said collapsing simultaneous operating said rear suspension to collapse said rear wheels toward said frame.

2. The golf bag cart of claim 1, and further including:
a handle pivotally attached to said frame.

3. The golf bag cart of claim 1, wherein:
a slider block is provided on said frame to coordinate the simultaneous collapse into said storage mode and subsequent simultaneous expansion into said use mode.

4. The golf bag cart of claim 3, wherein:
said support frame includes a torso frame portion pivotally attached to a base frame, with said slider block being mounted on said base frame, and force extensions pivotally extend between attachment collars secured to said torso frame and said slider block; and
said slider block is forced to slide laterally upon said base frame by said force extensions when said torso frame is pivoted forward and downward to said storage mode or backward and upward to said use mode.

5. The golf bag cart of claim 4, wherein:
said slider block is further pivotally connected to said collapsible rear suspension by a pair of connector rods such that when said slider block slides forward, said rear wheel suspension is drawn forward into said storage mode and when said slider block slides rearward, said rear wheel suspension is forced into said use mode.

6. The golf bag cart of claim 1, wherein:
said four wheel carriage includes two rear wheels, each of said rear wheels being supported on a parallelogram suspension structure such that said rear wheels remain parallel to each other in said storage mode, said use mode and in transition therebetween.

7. The golf bag cart of claim 1, and further including
a mechanical locking mechanism to secure said support frame in said use mode.

8. A cart frame, comprising:
a tubular base frame having a pair of base tubes which are parallel and spaced apart for a portion of their expanse;
a pair of front wheels attached to said base frame forward of said parallel portion of expanse;
a torso frame pivotally attached to said base frame at a pivot location; and
a rear wheel suspension carriage pivotally attached to said base frame and terminating in a pair of spaced apart rear wheels; wherein
a slider block is slidably secured on said base tubes along said parallel expanse and pivotally connected to a portion of said torso frame removed from said pivot location; and
said slider block is connected by connector rods to said rear wheel suspension carriage such that sliding of said slider block in response to pivoting of said torso frame causes said rear wheel suspension carriage to collapse or expand the spacing between said rear wheels, depending on the direction of said pivoting.

9. The cart frame of claim 8, wherein
said base tubes are angled apart from each other near said front wheels to form, together with an axle extending between said front wheels, a bag bottom cradle.

10. The cart frame of claim 9, wherein
a bag bottom flap is pivotally attached to said axle to further support the bottom of a golf bag.

11. The cart frame of claim 8, wherein
a cam buckle is provided on said slider block to pivotally extend to and engage a cam catch ledge secured to said pivot location, said cam buckle being mechanically engaged with said cam catch ledge and secured in position by a cam lock paddle to lock said frame into an expanded mode for use.

12. The cart frame of claim 8, and further including
a handle pivotally attached to the end of said torso frame opposite said pivot location, said handle being securable in at least two pivot locations by engagement of a spring latch mounted on said torso frame, said spring latch having at least two grasping notches for engaging a latch rod on said handle.

13. The cart frame of claim 12, wherein
a hand brake lever is located on said handle, said hand brake lever being mechanically connected to a brake engagement structure associated with one of said rear wheels, wherein
rotating said hand brake lever in one direction causes, in said brake engagement structure, a brake pin to engage one of several pin receiving holes formed in a brake disc associated with said rear wheel to prevent rotation of said wheel, and rotating said brake lever in the opposite direction causes disengagement of said brake pin with said brake disc.

14. The cart frame of claim 12, wherein
a storage console is mounted on said handle to contain or retain various golf accessories.

15. The cart frame of claim 8, wherein
a bag top receiver is situated on said torso tube for elastically receiving the top portion of a golf bag between a pair of opposed mandibles.
